(19) United States
(12) Patent Application Publication
(10) Pub. No.: US 2019/0023411 A1
(43) Pub. Date: Jan. 24, 2019

(54) HYDROCARBON FUEL SYSTEM

(71) Applicant: Hamilton Sundstrand Corporation, Charlotte, NC (US)

(72) Inventors: Brian M. Welch, West Hartford, CT (US); Jonathan Rheaume, West Hartford, CT (US); Haralambos Cordatos, Colchester, CT (US); Joseph J. Sangiovanni, West Suffield, CT (US)

(21) Appl. No.: 15/657,727

(22) Filed: Jul. 24, 2017

(51) Int. Cl. B64D 37/34; F02C 7/22; B64D 37/02

(52) U.S. Cl. CPC B64D 37/34; B64D 37/02; F02C 7/222

(57) ABSTRACT

Disclosed is a fuel system with a fuel tank containing hydrocarbon fuel, a hydrocarbon fuel flow path in fluid communication with the fuel tank, and a gas separation pump disposed on the flow path. The gas separation pump has a pump housing with an inner wall defining a cylindrical internal cavity. The pump housing includes an inlet at a first axial position along the cylindrical cavity outer circumference, an outlet at a second axial position along the cylindrical cavity outer circumference, and a vacuum connection in fluid communication with the cylindrical cavity axis. A first impeller with an outer edge configured to sweep along the inner wall is axially disposed between the inlet and the outlet. A second impeller configured to eject liquid through the fluid outlet is axially disposed between the first impeller and the outlet.

### BACKGROUND

The subject matter disclosed herein generally relates to hydrocarbon fuel processing and delivery, and more particularly to removal of dissolved gases from a hydrocarbon fuel stream.

Hydrocarbon fuels can be thermodynamically characterized as high-energy, low-entropy materials, and are utilized for their characteristic of being chemically unstable under certain conditions so that the fuel readily reacts with atmospheric oxygen in a highly exothermic combustion reaction. Liquid hydrocarbon fuels are typically prepared through the chemical refining of crude oil. However, liquid hydrocarbon fuels can contain substances other than the moderately short-chain hydrocarbons that make up the bulk of the liquid fuel. For example, they can contain dissolved contaminants or by-products from the refining process. Other contaminants such as dissolved gases can be introduced to the liquid fuel through contact with gases (e.g. the surrounding atmosphere) during storage or transportation. Contaminants such as dissolved gases can cause performance problems for fuel system or engine operation and components, and although various technologies have been proposed for removing gases from fuels, new approaches continue to be sought.

### BRIEF DESCRIPTION

Disclosed is a fuel system comprising a fuel tank containing hydrocarbon fuel, a hydrocarbon fuel flow path in fluid communication with the fuel tank, and a gas separation pump disposed on the flow path. The gas separation pump comprises a pump housing comprising an inner wall defining a cylindrical internal cavity. The pump housing comprises an inlet at a first axial position along the cylindrical cavity outer circumference, an outlet at a second axial position along the cylindrical cavity outer circumference, and a vacuum connection in fluid communication with the cylindrical cavity axis. A first impeller comprising an outer edge configured to sweep along the inner wall is axially disposed between the inlet and the outlet. A second impeller configured to eject liquid through the fluid outlet is axially disposed between the first impeller and the outlet.

In some embodiments, the vacuum connection can be disposed at a radially central location along a first end of the inner cylindrical cavity closer to the axial position of the inlet than to the axial position of the outlet.

In some embodiments, the gas separation pump can further comprise a third impeller at an axial position between the inlet and the first end of the inner cylindrical cavity.

In some embodiments, the vacuum connection can be disposed at a second end of the inner cylindrical cavity closer to the axial position of the outlet than the axial position of the fluid inlet.

In some embodiments, the vacuum connection can be in fluid communication with a vacuum device, either integrated with or external to the gas separation pump, on a common rotor with the first and second impellers.

In some embodiments, the vacuum device can comprise a vacuum ejector.

In some embodiments, the first impeller, or the pump housing inner wall, or both the first impeller or the pump housing inner wall, can include an uneven surface in a region where the first impeller is configured to sweep during operation.

In some embodiments, the uneven surface can be configured to form eddy or vortex currents in pumped fluid during operation.

In some embodiments, the gas separation pump inlet can further comprise an orifice or Venturi tube.

In some embodiments, the fuel system can further comprise an inert gas source in fluid communication with an ullage space in the fuel tank.

In some embodiments, the inert gas source can comprise a catalytic reactor that combusts fuel vapor to form carbon dioxide and water.

In some embodiments, the fuel system can be configured to control a vacuum pressure at the vacuum connection based on temperature of the liquid hydrocarbon fuel.

Also disclosed is an engine fueling system comprising the fuel system of any one or combination of the above embodiments and an engine that receives fuel from the hydrocarbon fuel flow path.

In some embodiments, the engine fueling system can further comprise a scavenge pump on the hydrocarbon fluid flow path between the fuel tank and the gas separation pump inlet, wherein fuel flow output from the gas separation pump or a boost pump provides motive force to the scavenge pump.

In some embodiments, the engine fueling system can further comprise a heat exchanger comprising a heat absorption side on the hydrocarbon fuel flow path and a heat rejection side in thermal communication with a heat source.

In some embodiments, the engine can comprise a gas turbine aircraft engine, and the heat source comprises engine lubricating oil.

Also disclosed is a method of assembling a fuel system comprising fluidly connecting a fuel tank containing a hydrocarbon fuel to an inlet of a gas separation pump, and fluidly connecting the gas separation pump outlet to a fuel delivery outlet. The gas separation pump comprises a pump housing comprising an inner wall defining a cylindrical internal cavity. The pump housing comprises an inlet at a first axial position along the cylindrical cavity outer circumference, an outlet at a second axial position along the cylindrical cavity outer circumference, and a vacuum connection in fluid communication with the cylindrical cavity axis. A first impeller comprising an outer edge configured to sweep along the inner wall is axially disposed between the inlet and the outlet. A second impeller configured to eject liquid through the fluid outlet is axially disposed between the first impeller and the outlet.

Also disclosed is a gas separation pump comprising a pump housing comprising an inner wall defining a cylindrical internal cavity. The pump housing comprises an inlet at a first axial position along the cylindrical cavity outer circumference, an outlet at a second axial position along the cylindrical cavity outer circumference, and a vacuum connection in fluid communication with the cylindrical cavity axis. A first impeller comprising an outer edge configured to sweep along the inner wall is axially disposed between the inlet and the outlet. The first impeller, or the pump housing inner wall, or both the first impeller or the pump housing inner wall, includes an uneven surface in a region where the first impeller is configured to sweep during operation. A second impeller configured to eject liquid through the fluid outlet is axially disposed between the first impeller and the outlet.

### BRIEF DESCRIPTION OF THE DRAWINGS

The following descriptions should not be considered limiting in any way. With reference to the accompanying drawings, like elements are numbered alike:

FIG. 1 is a schematic depiction of an example embodiment of a fuel system;

FIG. 2 is a schematic depiction of another example embodiment of a fuel system;

FIG. 3 is a schematic depiction of an example embodiment of a gas separation pump;

FIG. 4 is a schematic depiction of another example embodiment of a gas separation pump;

FIG. 5 is a schematic depiction of an example embodiment of a gas separation pump with an integrated vacuum source;

FIG. 6 is a schematic depiction of an example embodiment of a gas separation pump and an external vacuum source;

FIG. 7 is a schematic depiction of an example embodiment of a gas separation pump and an external ejector; and

FIG. 8 is a schematic depiction of an example embodiment of a separation pump with an uneven surface in an impeller sweep zone.

### DETAILED DESCRIPTION

A detailed description of one or more embodiments of the disclosed apparatus and method are presented herein by way of exemplification and not limitation with reference to the Figures.

Various embodiments of the present disclosure are related to the removal of dissolved gaseous species (e.g. oxygen, carbon dioxide, water vapor, etc.) from fuel. In some embodiments, for example, hydrocarbon fuel can serve as a heat sink on aircraft or other vehicles by absorbing heat from an engine, engine accessories, and other heat loads. At high temperature, however, the fuel can react with dissolved oxygen to form solid carbonaceous deposits (“varnish” or “lacquering”) in fuel passages. The deposits can foul surfaces for heat exchange and clog fuel system components. When fuel is heated above approximately 250° F., the increased rate of these auto-oxidation reactions can shorten typical fuel system maintenance intervals. Further, water in fuel can also be problematic because water degrades the heating value of fuel. Water can also freeze in the fuel system and block fuel flow. Water can also allow microorganisms to grow in fuel that can occlude flow of fuel and whose metabolic byproducts contribute to corrosion of fuel system components. Additionally, carbon dioxide in fuel may also be problematic. Carbon dioxide in fuel can cause vapor lock or fuel pump cavitation under certain conditions. Vapor lock is the undesired presence of gases and vapors in the fuel system that can adversely affect delivery of fuel to the engine. Carbon dioxide and water can get into fuel through exposure to the environment, or in some embodiments through fuel tank inerting systems that provide a nonflammable gas by catalytic combustion to form carbon dioxide and water, which can present a risk of vapor lock or cavitation when dissolved in fuel. Many approaches for removing dissolved gases from hydrocarbon fuels have utilized selective membranes that can have high bulk and weight and limited durability. This disclosure seeks to address the issue of dissolved gases in fuel with embodiments that can be used as an alternative to or in combination with other gas removal technologies such as selective membranes.

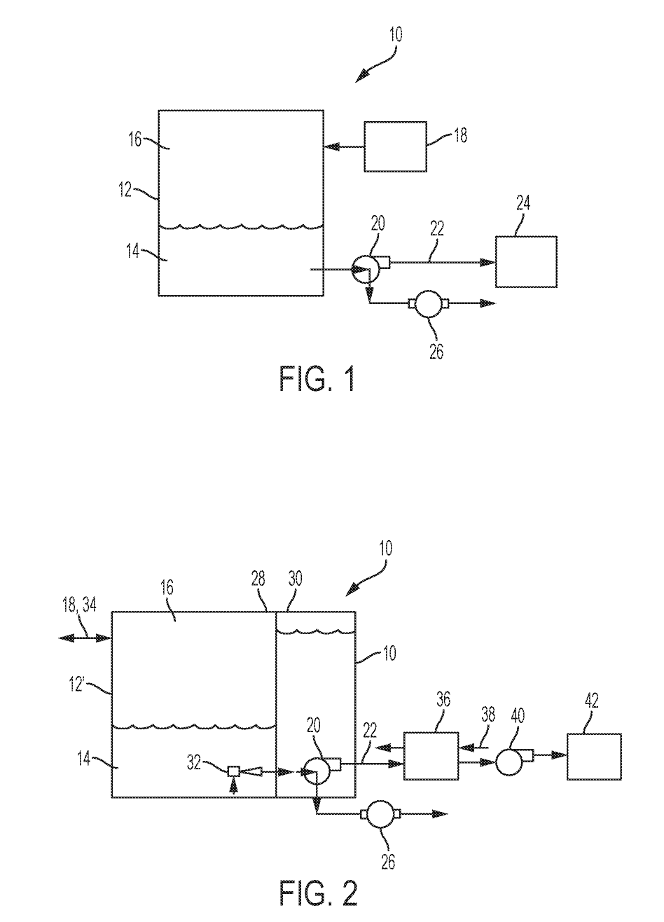

With reference now to the Figures, FIGS. 1 and 2 schematically show example embodiments of a fuel system 10. The fuel system 10 includes fuel tank 12 that contains liquid hydrocarbon fuel 14 and a vapor or ullage space 16. In some embodiments, an optional non-flammable gas system 18 can provide non-flammable gas to the fuel tank ullage space 16. A gas separation pump 20 receives the liquid hydrocarbon fuel 14 from the fuel tank 12 and removes dissolved gas(es) from the liquid fuel, sending the degassed fuel to fuel system delivery outlet 22. As shown in FIG. 1, the gas separation pump 20 is located outside of the fuel tank 12, but it can also be located in the tank, either submerged in the fuel 14 (see, e.g., FIG. 2) or above or partially submerged in the fuel 14 with a submerged inlet feed line (not shown). As shown in FIG. 1, the fuel system delivery outlet 22 delivers fuel to a fuel delivery target 24, which can be an engine, another fuel tank (e.g., pumping from a fuel storage tank to a vehicle on-board fuel tank), or a fuel processing system such as a thermal management system (TMS) that heats or cools the fuel or subjects it to other chemical or physical processing. Gas(es) removed from the liquid fuel 14 are exhausted through a vacuum pump 26. In some embodiments, the fuel tank 14, the gas separation pump 20, and the fuel delivery target (e.g., engine, TMS) can all be vehicle on-board components. As used herein, the term “vehicle” means any transportation device, including automobiles, rail, marine, aircraft, or other transport vehicles. In some embodiments, the components can be part of an on-board aircraft fuel system.

An example embodiment of an on-board aircraft fuel system is schematically shown in FIG. 2. As shown in FIG. 2, fuel in aircraft wing fuel tank 12′ is pumped from a main tank section 28 to a collector cell 30 by a scavenge pump 32. Vent system 34 allows for gas outflow and inflow during aircraft ascent and descent and to accommodate for fuel consumption, and can also be integrated with a non-flammable gas system 18. In some embodiments, the scavenge pump 32 can be an ejector-style pump that relies on fluid flow from a fluid flow source such as a connection (not shown) to the output of a fuel booster pump such as booster pump 40 referenced below. The fuel separation pump 20 is shown submerged in the fuel 14 in collector cell 30, and outputs degassed fuel through the fuel system delivery outlet 22 to a thermal management system 36. The thermal management system 36 is represented schematically as a heat exchanger with the degassed fuel on its heat absorption side and aircraft engine lubricating oil 38 on its heat rejection side (oil connection to engine not shown), but could be another heat source that rejects heat to the fuel such as a bleed air cooler or engine structural components that need cooling. Heated fuel exiting from the thermal management system 36 can be recycled to the fuel tank 12 or directed to booster pump 40, which boosts the pressure of the liquid fuel for delivery to a fuel inlet of aircraft engine 42 (e.g., a gas turbine engine). In another example embodiment, the gas separating pump can be configured as the booster pump.

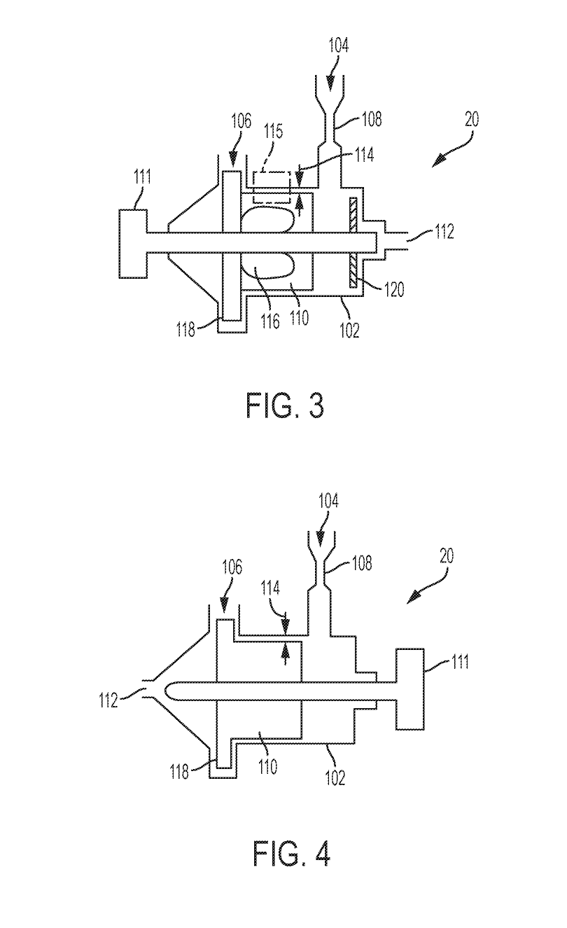

With reference now to FIGS. 3-4, example embodiments of a gas separation pump 20 are schematically shown. As shown in FIGS. 3-4, the gas separation pump 20 comprises a cylindrical pump housing 102 that includes an inlet 104 and an outlet 106. In some embodiments, the inlet 104 can optionally include an orifice or Venturi structure 108, which can provide a pressure drop to promote the formation of gas bubbles coming out of solution with the liquid hydrocarbon fuel. A first impeller 110 comprising one or more axially-extending blades is shown radially mounted on a rotor 111, which can have its own motor as shown or can be attached to another rotary drive chain such as an aircraft engine gearbox or an APU. During operation, the first impeller 110, which can also be referred to as an inducer or an inducer impeller pushes the liquid fuel radially outward toward the inner wall of the cylindrical pump housing 102. Concurrently with the action of the inducer directing liquid fuel radially outward, a vacuum is drawn at vacuum connection (i.e., vacuum port) 112 to promote formation of a low pressure space radially inward from the radially outwardly disposed liquid fuel. As the impeller 110 rotates, its radially-outward edge sweeps across the inner wall, promoting the formation of a liquid film in the gap 114. A body of liquid fuel with entrained gas can rotate along within the space between the blades of impeller 110 radially inward from the gap 114 and radially outward from the axially extending radially central (i.e., toward the axis) low pressure space. In some embodiments, such as shown in FIG. 3, the blades of the first impeller 110 can include one or more cutouts 116, for example at a radially central location on the blade that sweeps through the radially central low pressure space. A second impeller 118 connected to the rotor 111 ejects degassed liquid fuel radially through outlet 106 and provides motive force for the transport of fuel axially through the pump. In some embodiments, the first impeller 110 can comprise one or more axially-extending flat blades radially disposed to rotate in the in the cylindrical pump housing 102, and the second impeller 118 can comprise a plurality of vanes (not shown) configured to direct liquid fuel radially outward through the outlet 106. In some embodiments, the first impeller 110 can comprise one or more helical impeller configured to transport the fuel axially along the inside of housing 102. In some embodiments, the second impeller 118 can be a separate structure from the first impeller 106 as shown in FIG. 3. In some embodiments, the second impeller 118 can be structurally integrated with the first impeller 106 as shown in FIG. 4.

FIG. 4 schematically shows a gas separation pump with similar features and numbering as shown for FIG. 3. FIGS. 1 and 2 differ primarily in the location of the vacuum connection 112, with FIG. 3 having the radially central vacuum connection disposed axially remote from the outlet 106 so that the vacuum pulls in the opposite axial direction as the liquid flow, and FIG. 4 having the vacuum connection disposed on same end as outlet 106 so that the vacuum pulls in the same axial direction as the liquid flow. The pump can also include an optional third impeller 120 (FIG. 3) on the rotor 111 to inhibit liquid from being evacuated through the vacuum connection 112 and re-direct such liquid radially outward on a flow path toward the outlet 106. The second impeller can perform this function in the embodiment of FIG. 4 because of its proximity to the vacuum connection 112.

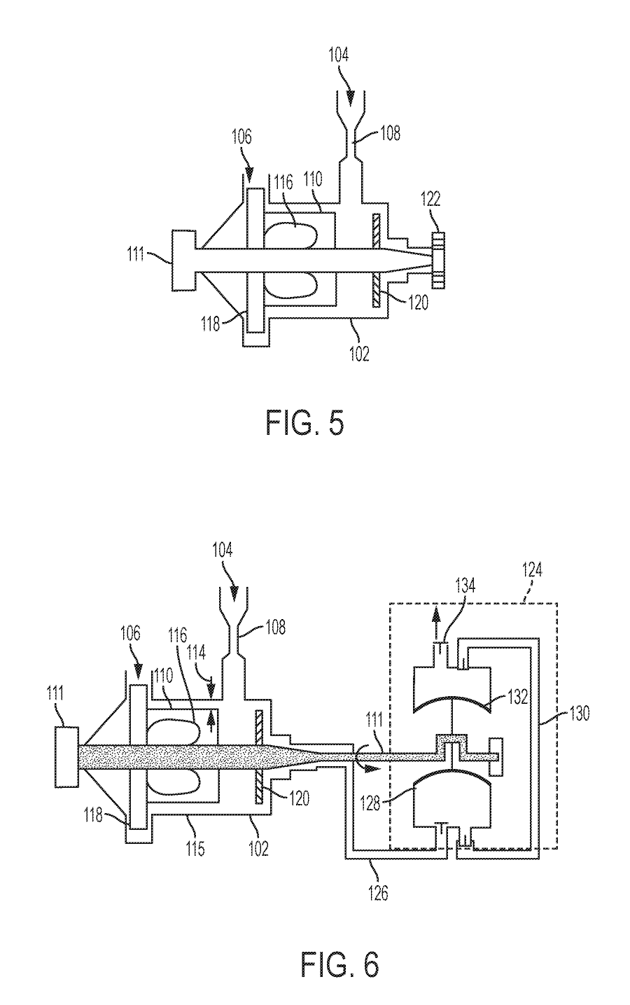

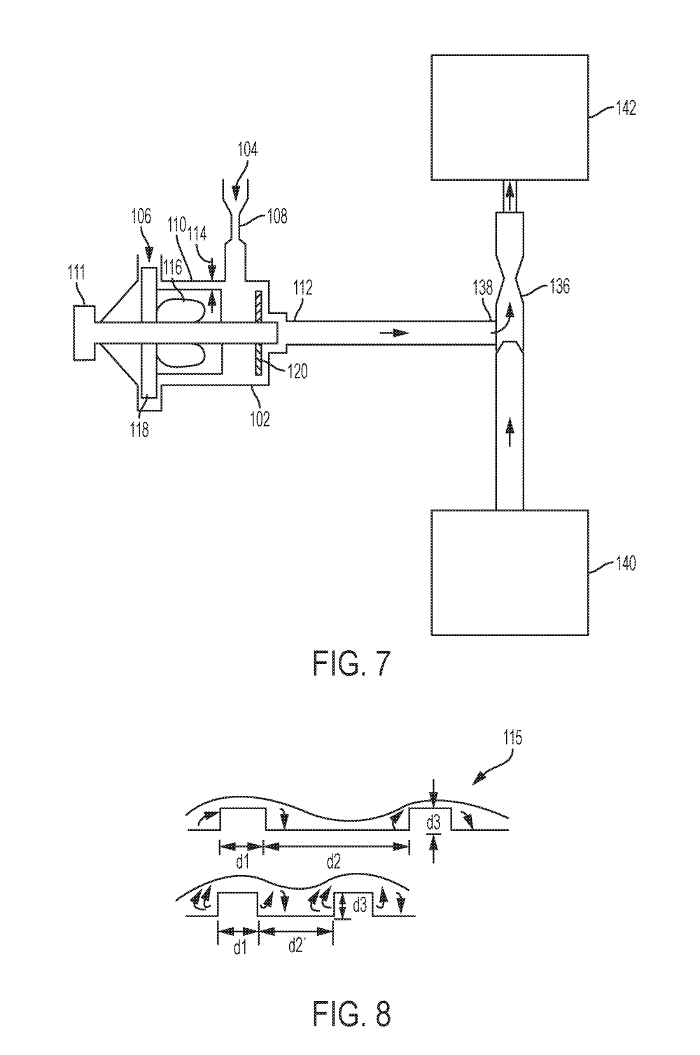

Various types of vacuum devices can be used as the vacuum pump 26. For example, in some embodiments a rotary vane vacuum pump can be used as vacuum pump 26. In some embodiments, a vacuum can be generated by a vacuum generation device as described in U.S. patent application Ser. No. 15/587,669 entitled “Vacuum Systems for Degassing of Liquid Hydrocarbon Fuels”, the disclosure of which is incorporated herein by reference in its entirety. In some embodiments, the vacuum pump 26 can be integrated with the gas separation pump 20, and in some embodiments, the vacuum pump 26 can be external to the gas separation pump 20. In some embodiments, the vacuum pump can be on or powered by the same rotor as the impellers of the gas separation pump 20. FIGS. 5-7 schematically show example embodiments of gas separation pumps integrated with vacuum devices. FIG. 5 shows an integrated vacuum pump 122 (exhaust not shown) such as a rotary vane vacuum pump or a scroll vacuum pump that is mounted on the same rotor 111 as the impellers 110, 118, and 120. FIG. 6 shows an external vacuum pump 124 such as a diaphragm pump with multiple heads that shares the same power train (rotor 111) as the gas separation pump 20. Vacuum is drawn through conduit 126 by a first diaphragm 128, and a second diaphragm 130 draws vacuum from the first diaphragm 128 through conduit 132, which exhausts through exhaust port 134. The two vacuum stages are configured in series for deeper vacuum; parallel configuration for higher flow is also envisioned. FIG. 7 schematically shows an external vacuum ejector 136 comprising a suction port 138 in fluid communication with the degassing pump vacuum connection 112. A motive fluid from a high pressure fluid source 140 (e.g., bleed air) provides motive force to draw a vacuum at vacuum port 138 through the Venturi effect. The motive fluid exits the vacuum ejector 136 to motive fluid sink 142, which can be an on-board system that uses the motive fluid or an external exhaust. It should be noted that FIG. 7 shows a single stage ejector, but that multi-stage ejectors where the motive fluid exiting the ejector is directed to a vacuum port of another downstream ejector are also envisioned. A vacuum ejector can also be connected in series with a vacuum pump such as a rotary vane, scroll, or diaphragm vacuum pump.

As mentioned above, some embodiments can provide a technical effect of removing dissolved gases from liquid hydrocarbon fuel. In some embodiments, the processing of liquid hydrocarbon fuel for removal of dissolved gases can be promoted in various ways. For example, in some embodiments, features can be included in the gas separation pump 20 to enhance mass transfer for the evolution of gases such as oxygen, nitrogen, and carbon dioxide in the region where the inducer impeller sweeps along the inner wall of the pump housing 102. In some embodiments, such features can include an uneven surface on the pump housing inner wall or on the blade edge of the inducer impeller. Example embodiments of such features are is shown in FIG. 8, which schematically represents a magnified view of the region 115 of the gas separation pump 20 from FIG. 3. As shown in FIG. 8, variations on a textured surface show a rectangular notch pattern. Straight rib-like structures with sharp edges such as those shown in FIG. 8 can promote the formation of eddy currents in the liquid shown flowing over the uneven surface, which can promote mass transfer for oxygen evolution. By varying the relative dimensions d1, d2, and d3 shown in FIG. 8, the skilled person can implement structures to promote the formation of eddy currents. For example, as shown in the example embodiment of FIG. 8, shortening the dimension d2 to d2′ increases the eddy currents. Other configurations can be implemented by the skilled person depending on the specific operational parameters involved.

In some embodiments, the level of vacuum can be varied. A deep vacuum can generally promote evolution of gas from the liquid fuel, but increased levels of vacuum can also promote evaporation of lighter fractions (lower molecular weight hydrocarbons) in the fuel and can lead to pump cavitation. Although any fuel lost to the vacuum exhaust can be recaptured downstream by a condenser or a reverse selective membrane, it can be beneficial in some embodiments to control the vacuum level to inhibit fuel loss. A vacuum level of about 50 torr absolute pressure can removed dissolve gases in liquid hydrocarbon fuel at 50° C. without excessive fuel evaporation, but may be less effective at lower temperatures. However, the vapor pressures of the liquid hydrocarbon fractions are also reduced at lower temperatures, so that a deeper vacuum can be drawn at lower temperatures without excessive fuel evaporation. In some embodiments, the fuel system is configured to operate (e.g., includes a controller configured to operate the system) to vary the vacuum pressure based on the fuel temperature. In some embodiments, the fuel system is configured to operate (e.g., includes a controller configured to operate the system) to reduce the vacuum pressure with reduced temperature and to increase the vacuum pressure with increased temperature. Increasing the residence time of the liquid hydrocarbon fuel in the pump can promote evolution of dissolved gases from the liquid fuel. In some embodiments, the pump can be configured and operated to provide a minimum residence time of at least 5 milliseconds (ms), or at least 25 ms, or at least 250 ms for fuel at room temperature. These range endpoints can be independently combined to form a number of ranges, and each possible range is hereby explicitly disclosed.

In some embodiments, the gas separation pump can be outfitted with seals and other materials that are compatible with hydrocarbon fuels. For example, seal materials can be a fluoropolymer elastomer or a fluorosilicone rubber. Aluminum for the pump housing and rotors is compatible with kerosene-based fuels such as aviation fuel Jet A-1. In some embodiments, copper conduits should be avoided, as should brass fittings because they can catalyze the auto-oxidation reactions of dissolved oxygen in the fuel. Seals and materials should not only be chemically compatible with fuel, they should also be compatible with temperature in which in which the gas separation pump is subjected to subfreezing temperatures during the cold soak condition. For example, some commercially available fluoroelastomer materials are compatible with a wide range of temperatures from −50° C. to +200° C.

The terminology used herein is for the purpose of describing particular embodiments only and is not intended to be limiting of the present disclosure. As used herein, the term “about” is intended to include the degree of error associated with measurement of the particular quantity based upon the equipment available at the time of filing the application. For example, “about” can include a range of ±8% or 5%, or 2% of a given value. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fuel system comprising a fuel tank containing hydrocarbon fuel;
a hydrocarbon fuel flow path in fluid communication with the fuel tank;
a gas separation pump disposed on the flow path, comprising:
a pump housing comprising an inner wall defining a cylindrical internal cavity, said pump housing comprising an inlet at a first axial position along the cylindrical cavity outer circumference, an outlet at a second axial position along the cylindrical cavity outer circumference, and a vacuum connection in fluid communication with the cylindrical cavity axis;
a first impeller axially disposed between the inlet and the outlet, said first impeller comprising an outer edge configured to sweep along the inner wall;
a second impeller axially disposed between the first impeller and the outlet, said second impeller configured to eject liquid through the fluid outlet.

2. The fuel system of claim 1, wherein the vacuum connection is disposed at a radially central location along a first end of the inner cylindrical cavity closer to the axial position of the inlet than to the axial position of the outlet.

3. The fuel system of claim 2, wherein the gas separation pump further comprises a third impeller at an axial position between the inlet and the first end of the inner cylindrical cavity.

4. The fuel system of claim 1, wherein the vacuum connection is disposed at a second end of the inner cylindrical cavity closer to the axial position of the outlet than the axial position of the fluid inlet.

5. The fuel system of claim 1, wherein the vacuum connection is in fluid communication with a vacuum device, either integrated with or external to the gas separation pump, on a common rotor with the first and second impellers.

6. The fuel system of claim 5, wherein the vacuum device comprises a vacuum ejector.

7. The fuel system of claim 1, wherein the first impeller, or the pump housing inner wall, or both the first impeller or the pump housing inner wall, includes an uneven surface in a region where the first impeller is configured to sweep during operation.

8. The fuel system of claim 7, wherein the uneven surface is configured to form eddy or vortex currents in pumped fluid during operation.

9. The fuel system of claim 1, wherein the gas separation pump inlet further comprises an orifice or Venturi tube.

10. The fuel system of claim 1, further comprising an inert gas source in fluid communication with an ullage space in the fuel tank.

11. The fuel system of claim 10, wherein the inert gas source comprises a catalytic reactor that combusts fuel vapor to form carbon dioxide and water.

12. The fuel system of claim 1, wherein the fuel system is configured to control a vacuum pressure at the vacuum connection based on temperature of the liquid hydrocarbon fuel.

13. An engine fueling system comprising the fuel system of claim 1 and an engine that receives fuel from the hydrocarbon fuel flow path.

14. The engine fueling system of claim 13, further comprising a scavenge pump on the hydrocarbon fluid flow path between the fuel tank and the gas separation pump inlet, wherein fuel flow output from the gas separation pump or a boost pump provides motive force to the scavenge pump.

15. The engine fueling system of claim 13, further comprising a heat exchanger comprising a heat absorption side on the hydrocarbon fuel flow path and a heat rejection side in thermal communication with a heat source.

16. The engine fueling system of claim 15, wherein the engine comprises a gas turbine aircraft engine, and the heat source comprises engine lubricating oil.

17. A method of assembling a fuel system, comprising:
fluidly connecting a fuel tank containing a hydrocarbon fuel to an inlet of a gas separation pump comprising:
a pump housing comprising an inner wall defining a cylindrical internal cavity, said pump housing comprising the inlet at a first axial position along the cylindrical cavity outer circumference, an outlet at a second axial position along the cylindrical cavity outer circumference, and a vacuum connection in fluid communication with the cylindrical cavity axis;
a first impeller axially disposed between the inlet and the outlet, said first impeller comprising an outer edge configured to sweep along the inner wall; and
a second impeller axially disposed between the first impeller and the outlet, said second impeller configured to eject liquid through the fluid outlet; and
fluidly connecting the gas separation pump outlet to a fuel delivery outlet.

18. A method of assembling an engine fueling system, comprising assembling the fuel system of claim 17 and fluidly connecting the fuel delivery outlet to an engine.

19. The method of claim 18, wherein the engine is an aircraft gas turbine engine, and the method includes fluidly connecting the boost pump and a heat absorption side of an engine oil-cooling heat exchanger on a fuel flow path from the gas separation pump outlet to the engine fuel inlet.

20. A gas separation pump comprising
a pump housing comprising an inner wall defining a cylindrical internal cavity, said pump housing comprising the inlet at a first axial position along the cylindrical cavity outer circumference, an outlet at a second axial position along the cylindrical cavity outer circumference, and a vacuum connection in fluid communication with the cylindrical cavity axis;
a first impeller axially disposed between the inlet and the outlet, wherein the first impeller, or the pump housing inner wall, or both the first impeller or the pump housing inner wall, includes an uneven surface in a region where the first impeller is configured to sweep during operation; and
a second impeller axially disposed between the first impeller and the outlet, said second impeller configured to eject liquid through the fluid outlet.
